(19) United States
(12) Patent Application Publication
(10) Pub. No.: US 2008/0170649 A1
(43) Pub. Date: Jul. 17, 2008

(54) Programmable Synchronizer/Terminator Method and Apparatus

(76) Inventor: Marcellus C. Harper, Kavsville, UT (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/972,957

(22) Filed: Jan. 11, 2008

Related U.S. Application Data
(60) Provisional application No. 60/880,111, filed on Jan. 11, 2007.

(51) Int. Cl. H04L 27/00

(52) U.S. Cl. 375/356

(57) ABSTRACT

A digital signal synchronizer integrated circuit includes an input port which receives digital signals, programmable delay modules which synchronize the digital signals, and an output port which outputs the synchronized digital signals. A method of synchronizing a plurality of digital signals includes arranging synchronizer chips in a cascade and interconnecting the chips so that timing and control data may be communicated between the chips, connecting digital buses to the chips, synchronizing the digital signals carried by the digitals buses and outputting the synchronized signals.

### RELATED APPLICATIONS

This application claims the benefit under 35 U.S.C. § 119(e) of U.S. Provisional Patent Application No. 60/880,111 filed Jan. 11, 2007 entitled “Test Solutions and Methods for Difficult Case Signals Encountered in Automatic Test Equipment.” The afore mentioned application is incorporated herein by reference in its entirety.

### BACKGROUND

As electronic devices communicate at increasingly faster digital data rates, the high-speed signals become ever more sensitive to the physical and electrical characteristics of components within the electrical systems. For example, the relative timing of high-speed signals can be skewed when traces carrying signals have a different length. The difference in time it takes to communicate over a slightly longer trace length can cause for high-speed signals to lose synchronization. Additionally, delay in high-speed lines can also be caused by varying impedance or capacitance of other adjoining components or traces. It is also important to prevent reflection from an improperly terminated signal line. The reflection can disrupt the signal in the improperly terminated line and other lines by creating ripple and frequency resonances that travel back up the line from the improper termination. The reflection of high-speed signals can be prevented by the proper termination of the high-speed line at a downstream location.

### BRIEF DESCRIPTION OF THE DRAWINGS

The accompanying drawings illustrate various embodiments of the principles described herein and are a part of the specification. The illustrated embodiments are merely examples and do not limit the scope of the disclosure.

FIG. 1 is an illustrative diagram showing an exemplary signal synchronization circuit, according to principles described herein.

FIG. 2 is an illustrative diagram showing one exemplary embodiment of synchronizer/terminator chips in a cascade configuration, according to principles described herein.

FIG. 3 is an illustrative diagram showing the operation of synchronizer/terminator chips in synchronizing received signals, according to principles described herein.

FIGS. 4, 5A, 5B, and 5C illustrate exemplary embodiments of individual circuitry elements that could be used in a synchronizer/terminator chip, according to principles described herein.

Throughout the drawings, identical reference numbers designate similar, but not necessarily identical, elements.

### DETAILED DESCRIPTION

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As electronic devices communicate at increasingly faster digital data rates, the high-speed signals become ever more sensitive to the physical and electrical characteristics of components within the electrical systems. For example, the relative timing of high-speed signals can be skewed when traces that carried the signals have a different length. The difference in the time it takes to communicate over a slightly longer trace length can cause for high-speed signals to lose synchronization. Additionally, delay in high-speed lines can also be caused by varying impedance or capacitance of other adjoining components or traces. It is also important to prevent reflection from an improperly terminated signal line. The reflection can disrupt the signal in the improperly terminated line and other lines by creating ripple and frequency resonances that travel back up the line from the improper termination. The reflection of high-speed signals can be prevented by the proper termination of the high-speed line at a downstream location.

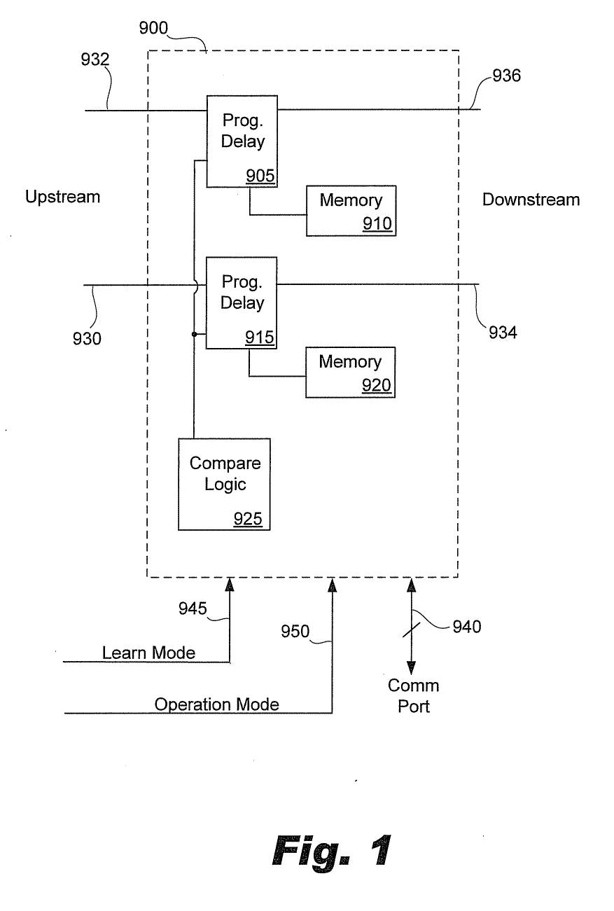

FIG. 1 illustrates one exemplary embodiment of the programmable delay and termination chip (900). Each programmable delay and termination chip (900) may be comprised of a multiple programmable delay modules (905, 915) and memory modules (910, 920). A plurality of upstream lines (932, 930) passes through the programmable delay and termination chip (900) and out the other side as downstream lines (936, 934). Each line passes through the programmable delay modules (905, 915). Although only two upstream lines (930, 932) are shown in FIG. 1, the principles described herein apply to programmable delay and termination chips (900) that have more input lines. By way of example and not limitation, eight or more upstream lines can be accommodated by the programmable delay and termination chip (900) by simply replicating the internal circuitry represented by the programmable delay module (905, 915) and the memory module (910, 920). The programmable delay modules (905, 915) are each controlled by compare logic (925). According to one exemplary embodiment, control logic (925) is configured to connect to any number of programmable delay modules.

External inputs to the chip may include a plurality of ports (940, 945, 950). The external inputs may include a two-way communication port (940) through which various control parameters and data may be communicated. These control parameters may include passing in synchronization or timing signals and designating which control line to reference as a base for synchronization. Additionally, the control settings may include drive level settings such as a high-voltage designator and a low-voltage designator for the input signal. The chip may also be placed in various operational modes by asserting various control lines. By way of example and not limitation, a learning mode (945) may be entered by asserting a first control line (945). An operational mode may similarly be entered by asserting a second control line (950).

According to one exemplary embodiment, each line passing through the programmable delay and termination chip (900) is bidirectional. Thus the programmable delay and termination chip (900) is capable of receiving information passing upstream or downstream and synchronizing the received signals. The designation of upstream and downstream directions in FIG. 1 is therefore arbitrary and is used only for purposes of explanation. In one embodiment, the programmable delay and termination chip (900) senses information conveyed on the bus lines (932, 930) to determine which direction the signal is originating from. By way of example and not limitation, the chip (900) could detect a source on one side of that forces levels within the chip (900). In another embodiment, the current passing into or out of the various signal lines could be measured to determine the direction of the signal propagation. The chip (900) may also have a bus hold feature which comprises a weak pull up/weak pull down function that maintains the present state of the signal when the input signal is removed or during periods of transition.

When the chip (900) is in learn mode it simply monitors the signals that pass through the signal bus and measures various delays of the signals it receives. When the operational mode is asserted the chip (900) uses the programmable delay modules (905, 915) to synchronize the received signals and pass them in the appropriate direction.

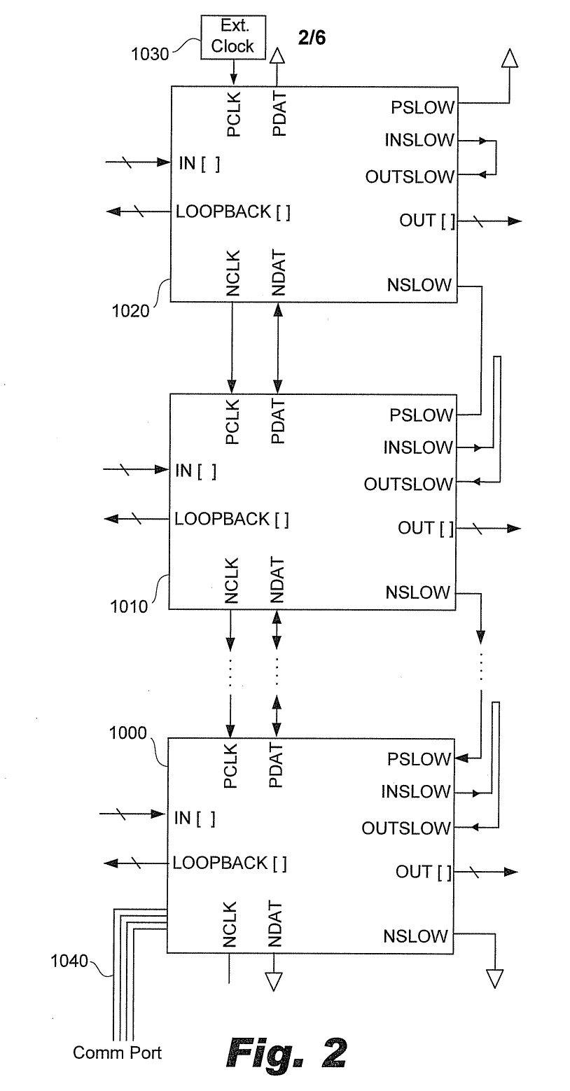

FIG. 2 shows a plurality of programmable delay and termination chips (1000, 1010, 1020) connected in a cascade. FIG. 2 illustrates additional details about various ports and communication between the programmable delay and termination chips (1000, 1010, 1020). According to one exemplary embodiment, a first programmable delay and termination chip (1000) has an “IN” port which is configured to receive a plurality of input lines comprising the upstream bus. A corresponding “OUT” port is configured to drive a plurality of output lines comprising the downstream bus. A “LOOPBACK” port is configured to return the received input signals from the “IN” port upstream to the originating device. The “LOOPBACK” port can be used to allow the originating system to determine timing delays within the various lines in the bus system, thereby providing an inexpensive calibration that could be used to synchronize the signals or altering design parameters such as trace length.

According to one exemplary embodiment, a plurality of “sync” lines is connected from one chip to the other to cascade multiple chips and synchronize a plurality of signal buses. These “sync” lines may comprise connections between clock ports such as the “PCLK” and “NCLK” ports, data ports such as the “PDAT” and “NDAT” ports, and timing ports such as the “NSLOW”, “PSLOW”, “INSLOW”, and “OUTSLOW” ports.

A first chip (1000) is a designated as “device 0”. The first chip (1000) is connected to a control device by a communication port (1040). According to one exemplary embodiment, the communication port (1040) may be an SPI port. The data communicated to the first chip (1000) is passed to the rest of the chips in the cascade by the two-way communication channel created between the connection “PDAT” and the “NDAT” on adjacent chips. The “NDAT” port of the first chip (1000) can be grounded indicating to the chip (1000) that it is the “device 0”.

A second chip (1010) is designated as the “device N−2”, while a third chip (1020) is designated as the “device N−1”. In the illustration shown in FIG. 2, only three programmable delay and termination chips (1000, 1010, 1020) are shown. However, additional chips could be interposed between the “device 0” and the “device N−2” as indicated by the dotted line interposed in the connecting lines between the first chip (1000) and the second chip (1010).

As discussed above, the data received by the first chip (1000) by the communication port (1040) is made available to the rest of the chips in a cascade by communication through the data line (PDAT/NDAT) that passes between the respective chips. The third chip (1020) is the terminal chip in a cascade. According to one exemplary embodiment the terminal chip in the cascade is connected to an external clock (1030) via its “PCLK” port. In addition, the “PDAT” port and the “PSLOW” port of the terminal chip (1020) can be grounded, thereby indicating to chip (1020) that it is the terminal chip in the cascade.

A timing signal that represents the slowest signal received from the bus connected to the input port of the terminal chip (1020) is passed from the “NSLOW” port of the terminal chip (1020) to the “PSLOW” port of the second chip (1010). A trace connecting the “INSLOW” and “OUTSLOW” ports of the second chip (1010) is designed to match the length of the connection between “NSLOW” port of the terminal chip (1020) to the “PSLOW” port of the second chip (1010). This allows the second chip (1010) to estimate the delay in receiving the timing signal generated by the terminal chip (1020) that was passed from the “NSLOW” port the “PSLOW” port.

An external clock signal received from the external clock (1030) is passed through the cascade of chips via a connection between the “NCLK” and “PCLK” ports of each chip. Alternatively, the same clock can be passed to all chips.

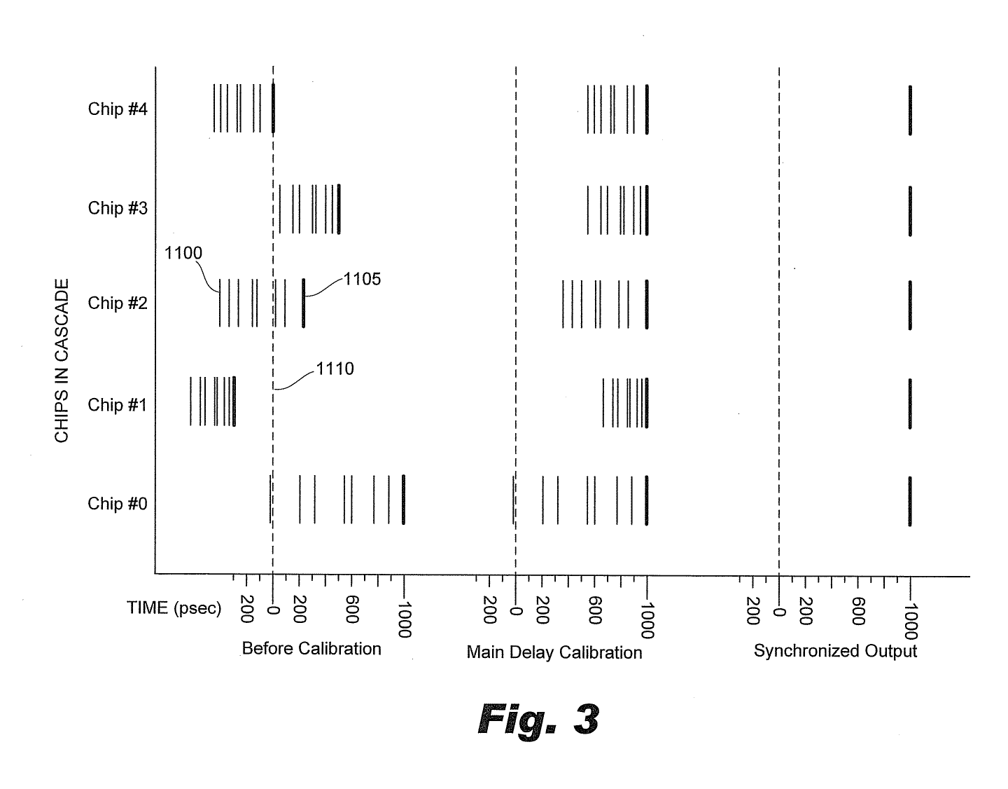

An example of the functional operation of cascaded programmable delay and termination chips is given in FIG. 3. In the example shown in FIG. 3, there are five chips in the cascade (Chip #0 through Chip #4). Each of the chips in the cascade is represented along the vertical axis of the graph. The horizontal axis of the graph represents time measured in picoseconds. Each of the five chips is connected via the “IN” port to a different eight line upstream bus. A control entity communicates to the chips in the cascade the nature of the signal and the specific characteristics of a triggering event within that signal via the communication port (1040, FIG. 2). The specific time that the triggering event on each of the eight signal lines received by each of the chips is designated by a plurality of vertical lines (1100) in the graph. A heavy dark line (1105) represents the time at which the slowest signal among the eight input lines was received by a given chip. The vertical lines are placed on the graph in a vertical position that corresponds to the chip at which the signal is received and in a horizontal position showing the time at which the given signal was received.

In this example, the terminal chip is designated as Chip # 4. The terminal chip begins recording the first triggering event among its eight signal lines at approximately −350 picoseconds as shown by the uppermost group of vertical lines. The terminal chip continues to receive triggering events and until it receives the final triggering event at 0 picoseconds. At this point, Chip # 4 communicates via the “NSLOW/PSLOW” line to Chip #3 that the maximum delay equals 0 picoseconds and the pass delay equals 0 picoseconds. The max delay is a value which represents the last trigger event which has occurred at a given point in the process. Because there are no chips beyond the terminal chip, the max delay is equal to the last triggering event of the terminal chip. The pass delay will be explained in a later example. The vertical dotted line (1110) represents the “base time” which is the time at which the last triggering event occurred at the terminal chip.

Chip #3 then waits until it receives its last triggering event from one of its input lines, which occurs at 500 picoseconds. Chip #3 then communicates to Chip #2 that the max delay is 500 picoseconds and the pass delay is 500 picoseconds. The maximum delay is now the latest event sensed thus far, which is Chip #3's last triggering event. According to one exemplary embodiment the pass delay for Chip #3 is equal to the pass previous delay minus the difference between Chip #4's actual delay and Chip #3's actual delay. The result of the calculation is the distance of the last triggering event from the “base time” as indicated by the vertical dashed line (1110). The general equation for pass delay is given below:

PD_{N}=PD_{N+1}−(AD_{N+1}−AD_{N}) (Eq. 1)

### Where

PD_{N}=pass delay for chip N

PD_{N+1}=previous pass delay for chip N+1

AD_{N+1}=Chip N+1's actual delay

AD_{N}=Chip N's actual delay

Chip #2 has already sensed its last triggering event at 220 picoseconds, and communicates a maximum delay of 500 picoseconds and a pass delay of 220 picoseconds. The pass delay for Chip #2 is equal to the previous pass delay minus the difference between Chip #3's actual delay and Chip #2's actual delay. Thus the calculation is as follows:

Pass delay for Chip #2=500−(500−220)=220 picoseconds (Eq. 2)

Chip #1 has already sensed its last triggering event at −300 picoseconds and passes a maximum delay of 500 picoseconds and a pass delay of −300 picoseconds to Chip #0.

Chip #0 is the first chip in the cascade and has measured its last triggering event a 1000 picoseconds. The maximum delay is then 1000 picoseconds, but Chip #0 does not have a chip lower in the cascade to which it must communicate this information. Instead Chip #0 knows that it has the maximum delay and the other chips must delay their signals to match its delay. Chip #0 then calculates the compensation value for Chip #1 by subtracting the pass delay for Chip #1 from the maximum delay. An equation for calculating compensation value is given below.

CV_{N+1}=CV_{N}−PD_{N+1} (Eq. 3)

### Where

CV_{N+1}=compensation value for chip N+1

PD_{N+1}=previous pass delay for chip N+1

CV_{N}=compensation value for chip N

Substituting the values for the variables in Eq. 3, the compensation value for Chip #1 can be calculated by Chip #0.

Compensation value for Chip #1=1000−(−300)=1300 picoseconds (Eq. 4)

Chip #0 than passes the compensation value of 1300 picoseconds to Chip #1. Chip #1 receives the value and delays its signals by 1300 picoseconds. Chip #1 then calculates the compensation value for Chip #2 using Eq. 3, which results in a compensation value for Chip #2 of 780 picoseconds. Similarly, Chip #2 passes a compensation value of 500 picoseconds to Chip #3. Chip #3 then passes a compensation value of 1000 picoseconds to Chip #4. After all of the main delays have been compensated for, the delayed signals are aligned as shown in the center portion of the graph shown in FIG. 3 with the last triggering event for each chip temporally aligned at 1000 picoseconds.

Each chip then internally delays the signals received by individual lines to match the last triggering event after main delay calibration. The end result is the signals on all 40 lines are synchronized at 1000 picoseconds, as illustrated in the right portion of the graph shown in FIG. 3.

The actions described above that are associated with calculating the delay required by each individual line comprise the learning mode of the chip cascade. Once the delay for each line has been calculated, the signals coming over each line can be appropriately synchronized. However, in a dynamic environment, the parameters that influence the delay can change over time. The chip cascade may be put back into the learning mode after a period of time to recalculate the appropriate delay for each line.

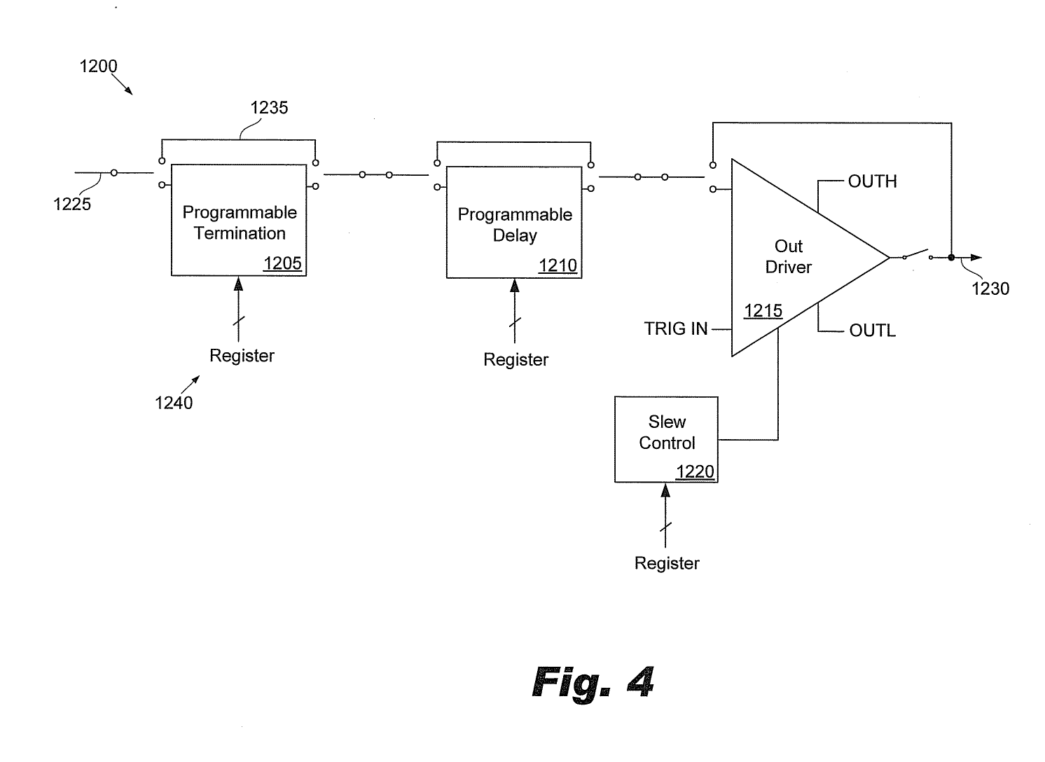

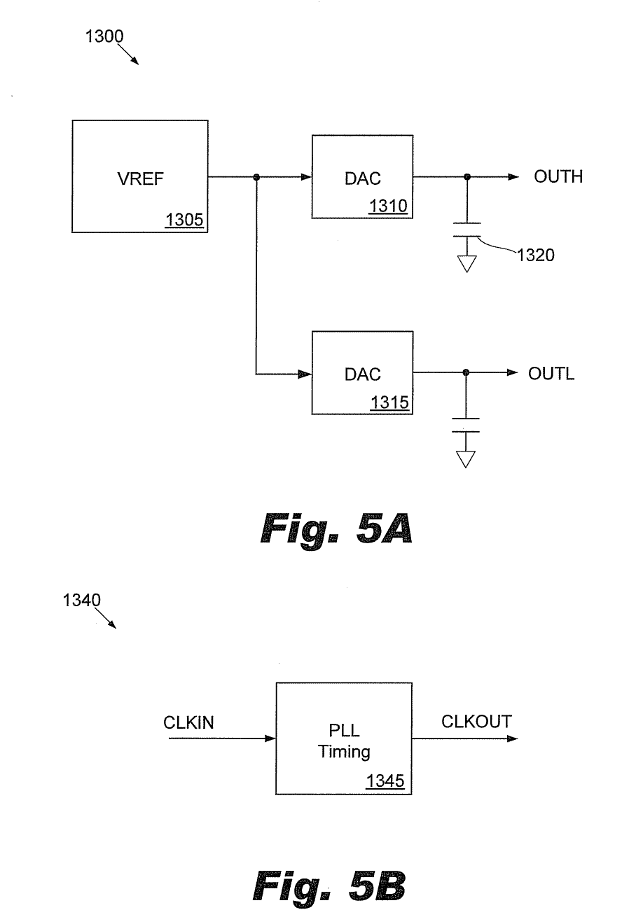

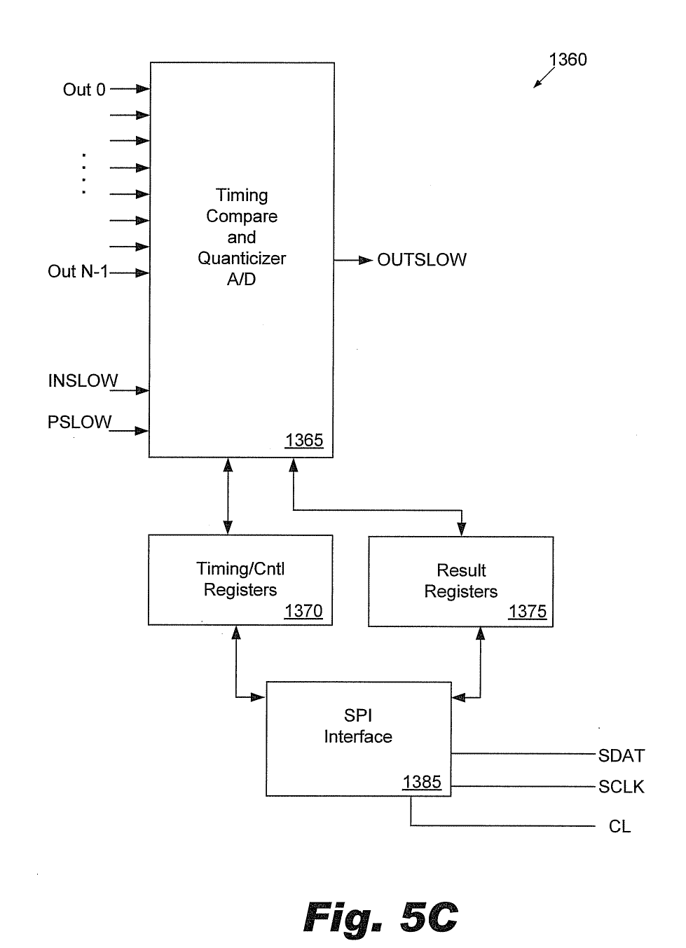

FIGS. 4, 5A, 5B, and 5C describe various components of the programmable delay and termination chip (900). FIG. 4 shows a signal path (1200) associated with a single line (1225, 1230). The entering line (1225) is shown on the left to the figure and the exiting line (1235) is shown on the right of the figure. A programmable termination module (1205) is available to terminate the entering line (1225). The proper termination of high-speed lines can be used to prevent undesirable reflections and ripple from returning upstream. The programmable termination module (1205) can be engaged using one of a plurality of switches. At another position, the switch would bypass the programmable termination module (1205). A programmable delay module (1210) can be used to synchronize the signals as described in FIG. 4. According to one exemplary embodiment, the programmable delay module (1210) consists of a programmable resistor, an inverter, and a capacitor which have an accumulated delay of approximately 100 picoseconds. Any number of these units may be inserted into the signal path to accumulate the appropriate delay. Similar to the programmable termination module (1205), switches enable the programmable delay module (1210) to be placed within the signal path or bypassed. Registers (1240) can be connected to various modules within the programmable delay and termination chip (900) to communicate data or control signals to the modules.

An output driver (1215) can be used to modify the signals. By way of example and not limitation, the output driver (1215) may change logic levels, which may be set using the “OUTH” and “OUTL” control lines. By way of example and not limitation, the “OUTH” line could be used to set the high state and “OUTL” could be used to set the low state. The slew control module (1220) could assist the out driver (1215) in modifying the slope of the rising and failing edges of the output signal. The signal path (1200) may be repeated for as many channels as are available on a given chip (900). For differential current mode outputs, OUTH and OUTL lines may be replaced by a current source and the output signal (1230) can be replaced by a differential pair.

FIG. 5A shows various sub components within a signal path (1200; FIG. 4). According to one exemplary embodiment the “OUTH” and “OUTL” lines are controlled by a voltage reference module (1305). The voltage reference module (1305) sets the appropriate and desired voltage into digital form for the “OUTH” and “OUTL” lines. The digital signal is received by a digital to analog converter (1310, 1315) which converts the digital signal supplied by the voltage reference module (1305) into an analog voltage which is then supplied to the appropriate line. According to one exemplary embodiment, grounded capacitor (1320) is inserted into the output lines servers as a filtering mechanism to improve signal quality. The grounded capacitor (1320) allows the passage of DC analog signals to the output lines, but restricts the passage of higher frequency transients in the output lines.

FIG. 5B shows a phase lock loop (PLL) timing module (1345) which accepts a “CLKIN” signal and produces a “CLKOUT” signal. According to one exemplary embodiment, the “CLKIN” signal is produced by the PCLK input shown in the FIG. 2. The timing module (1345) makes phase adjustments for the cascade and generates a output timing signal “CLKOUT” which is then directed to the NCLK output timing signal as shown and described in FIG. 2.

FIG. 5C shows the operation of the timing compare module (1365). According to one exemplary embodiment the timing and compare module (1365) receives a variety of input lines here labeled “Out 0” through “Out N−1”. Additionally the “INSLOW” and “PSLOW” lines are received by the by the timing and compare module (1365). Timing control register (1370) is connected to the timing compare module (1365). The timing control register 1370) contains overrides and other control parameters which may be useful in the operation of the timing compare module (1365). The results register (1375) contains the calculated delays generated by the timing compare module (1365). Both the timing control registers (1370) and the results registers (1375) could be contained within memory blocks (910, 920; FIG. 1). There could be many different communications interfaces for the chip. One example is an SPI interface (1385) that could provide communication with the timing control registers (1370) and the results registers (1375), both to load values into the registers and to retrieve values from the registers. According to one exemplary embodiment, the SPI interface (1385) receives a plurality of inputs including an “SDAT” line and an “SCLK” line. The SPI interface (1385) could be one embodiment of the communication port (1040; FIG. 2). When the modules are cascaded only one communication port (1040; FIG. 2) or SPI interface (1385) needs to be used for the entire cascade because the chips can pass information to one another via their already connected PDAT/NDAT lines. One SPI port (1385) can address an individual in/out line or register for any input/output signal across the cascade.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A digital signal synchronizer integrated circuit comprising:
an input port, said input port being configured to receive a plurality of digital signals;
a plurality of programmable delay modules, said programmable delay modules being configured to synchronize said plurality of digital signals;
a means for controlling said plurality of programmable delay modules;
an output port, said output port being configured to output said plurality of digital signals after synchronization.

2. The integrated circuit of claim 1, wherein said digital signal synchronizer is configured to perform bidirectional signal synchronization.

3. The integrated circuit of claim 2, wherein said digital signal synchronizer is configured to detect signal direction automatically, thereby automatically reversing the direction of a bus.

4. The integrated circuit of claim 1, further comprising a means for externally programming said digital signal synchronizer integrated circuit.

5. The integrated circuit of claim 4, further comprising a means for creating a cascade, said cascade comprising a plurality of said digital signal synchronizer integrated circuits, said cascade being configured to allow a plurality of signals to be synchronized using said separate digital signal synchronizer integrated circuits.

6. The integrated circuit of claim 5, further comprising a means for communication among said plurality of said digital signal synchronizers such that said digital signal synchronizers communicate timing information received by others said digital signal synchronizers within said cascade.

7. The integrated circuit of claim 5, further comprising a means of communicating with all of said digital signal synchronizer integrated circuits within said cascade via one of said digital signal synchronizer integrated circuits.

8. The integrated circuit of claim 7, wherein said means for communicating with all of said digital signal integrated circuits further comprises a means for communicating programming and status information.

9. The integrated circuit of claim 1, wherein said integrated circuit is further configured to manipulate the slew rate and logic levels of said plurality of digital signals received by said input port.

10. The integrated circuit of claim 9, wherein said integrated circuit is further configured to control the termination impedance of a plurality of signal channels connected to said input port or said output port.

11. The integrated circuit of claim 10, wherein said integrated circuit is connected to a load board typical of those found in Automated Test Equipment (ATE) applications.

12. A digital signal synchronizer integrated circuit comprising:
an input port, said input port being configured to receive a bus, said bus comprising a plurality of signal paths, said signal paths carrying digital signals;
a plurality of programmable delay modules, said programmable delay modules being configured to synchronize said digital signals;
a control module, said control module having an interface, said interface allowing an external control of said integrated circuit, said control module being in communication with said plurality of programmable delay modules;
a programmable termination module, said programmable termination module being configured to modify an impedance of a said signal path;
an out driver, said out driver being configured to control a slew and logic levels of a said digital signal.

13. A method of synchronizing a plurality of digital signals comprising:
arranging a first synchronizer chip and a second synchronizer chip in a cascade;
connecting a first digital bus to an input port of said first synchronizer chip and a second digital bus to an input port on said second synchronous or chip;
interconnecting said first synchronizer chip and said second synchronizer chip such that timing and control information may be passed from between said first and said second synchronizer chips;
synchronizing digital signals carried by said first digital bus and said second digital bus;
outputting said synchronize digital signals.

14. The method of claim 13, further comprising:
said first and said second synchronizer chips receive a plurality of digital signals from said first and said second digital bus, said first and said second digital buses comprising a plurality of signal paths, said signal paths carrying said plurality of digital signals;
said first and said second synchronizer chips recording times at which triggering events occur within said plurality of digital signals;
said first and said the second synchronizer chips communicating a compensation value, said compensation value being calculated from said times;
said first and said second synchronizer chips introducing a delay into said plurality of signal paths such that said digital signals are synchronized.
